(19) United States
(12) Patent Application Publication
(10) Pub. No.: US 2010/0130209 A1
(43) Pub. Date: May 27, 2010

(54) Methods for facilitating user control of handoffs

(76) Inventors: Cynthia Florkey, Fort Collins, CO (US); Ruth Schaefer Gayde, Naperville, IL (US); John Richard Rosenberg, Elmhurst, IL (US); Donna Michaels Sand, Redmond, WA (US)

Correspondence Address: Alcatel-Lucent;Docket Administrator-Room 2F-192, 600-700 Mountain Ave., Murray Hill, NJ, 07974-0636, US

(21) Appl. No.: 12/315,048

(22) Filed: Nov. 25, 2008

(51) Int. Cl. H04W 36/00

(52) U.S. Cl. 455/437; 370/331

(57) ABSTRACT

To address the need to have new techniques that are able to improve handoff decision-making, the network may employ a method such as that depicted in diagram 200 or 300. In one method, the network receives (201) a user handoff approval indication from a UE regarding handoff of the UE to a target cell and then determines (202) whether to allow the handoff based on this user handoff approval indication. In another method, the network compares (301) attributes of a target cell to stored user handoff policies associated with a UE to determine a user policy approval indication regarding handoff to the target cell and then determines (302) whether to allow the handoff based on this policy approval indication. These methods afford users greater control in managing handoffs in the more varied and less uniform networking landscapes that technologies such as femto cell technology are creating.

### FIELD OF THE INVENTION

The present invention relates generally to communication systems and, in particular, to facilitating user control of handoffs.

### BACKGROUND OF THE INVENTION

Current wireless technologies are challenged by RF coverage limitations indoors, e.g. in the home or in a large building. Femto cells allow multiple wireless devices to access in-home or in-building cell sites in addition to the public macro cell sites commonly used today. Femto cells may be deployed in private residences, in commercial enterprises, or in public spaces such as coffee shops, restaurants, libraries, etc.

However, the use of femto cells may vary considerably from what is typical of public macro cells. Some examples follow. Unlike a macro cell, a femto cell typically is not physically secured by the service provider. Such a femto cell may thus be subject to eavesdropping and other tampering. In another example, a femto cell service provider may provide relatively inexpensive data rates or charge less for services accessed via the provider's cell as compared to the same services accessed via an area macro cell. In yet another example, parents may desire to add restrictions to their child's use of particular applications or to their calling/texting habits when access is not via the home femto cell.

Just from this small sampling of examples, it is apparent that handoffs may adversely affect access to services in certain situations. Thus, it would be clearly desirable to have new techniques that are able to improve handoff decision-making in view of such developments in the wireless landscape.

### BRIEF DESCRIPTION OF THE DRAWINGS

FIG. 1 is a block diagram depiction of a communication system in accordance with multiple embodiments of the present invention.

FIG. 2 is a logic flow diagram of functionality performed by a communications network in accordance with various embodiments of the present invention.

FIG. 3 is a logic flow diagram of functionality performed by a communications network in accordance with various embodiments of the present invention.

FIG. 4 is a logic flow diagram of functionality performed by a communications network in accordance with various embodiments of the present invention.

FIG. 5 is a logic flow diagram of functionality performed by user equipment in accordance with various embodiments of the present invention.

FIG. 6 is a logic flow diagram of functionality performed by user equipment in accordance with various embodiments of the present invention.

FIG. 7 is a logic flow diagram of functionality performed by user equipment in accordance with various embodiments of the present invention.

FIG. 8 is a detailed block diagram depiction of a wireless communication system in accordance with certain embodiments of the present invention.

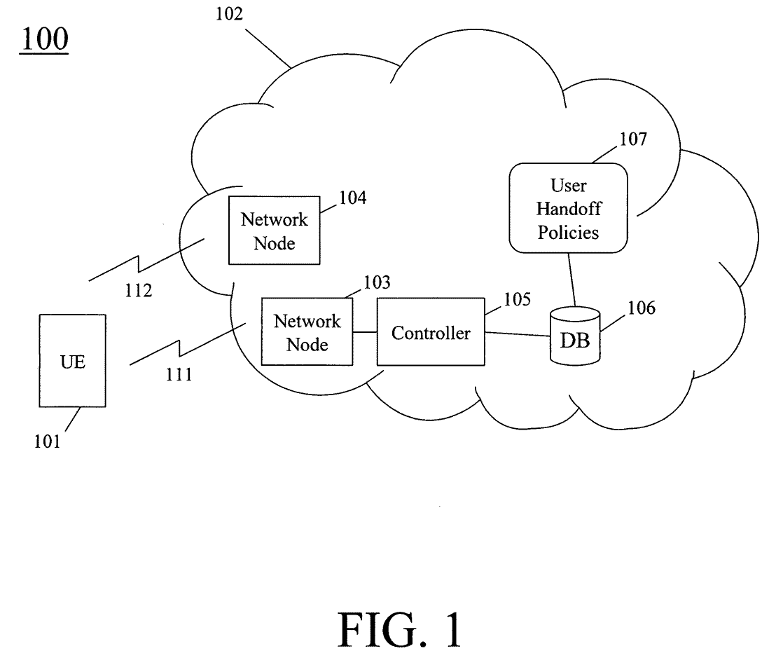

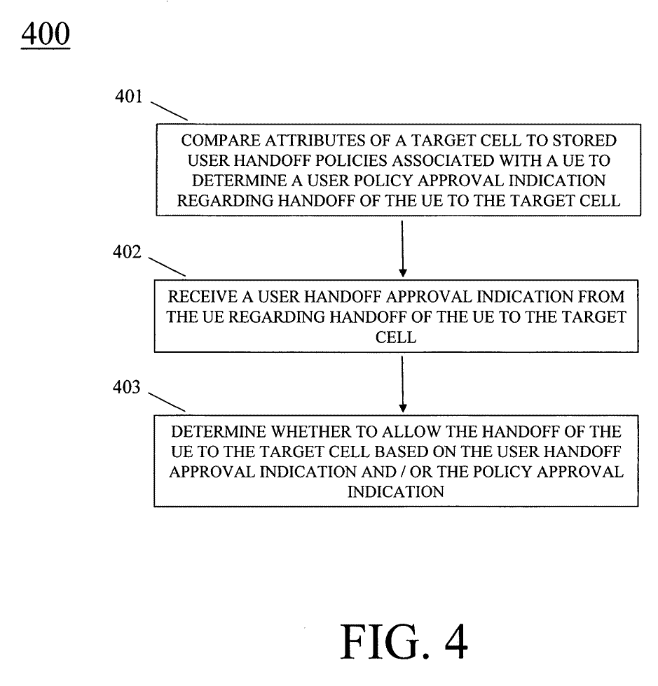

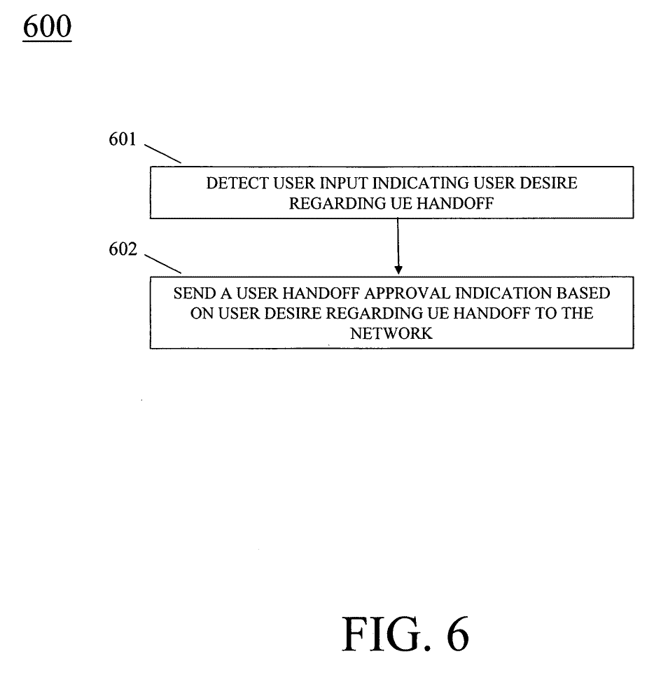

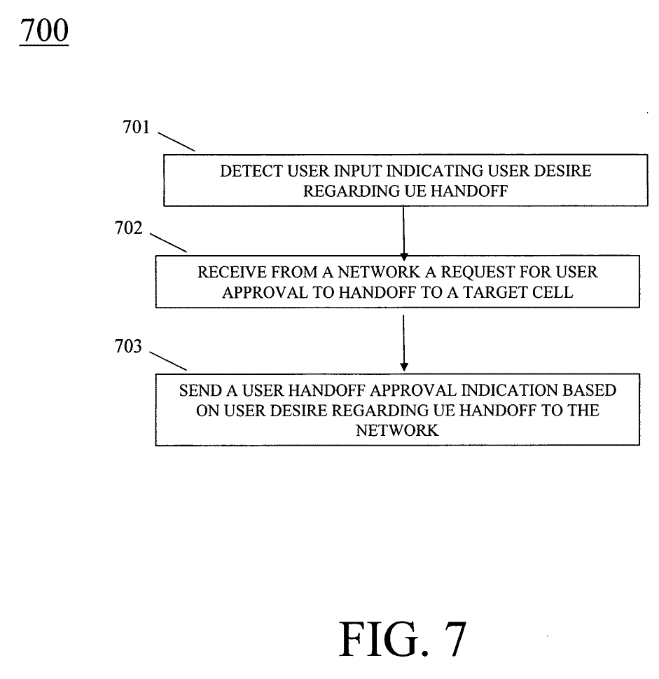

Specific embodiments of the present invention are disclosed below with reference to FIGS. 1-8. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

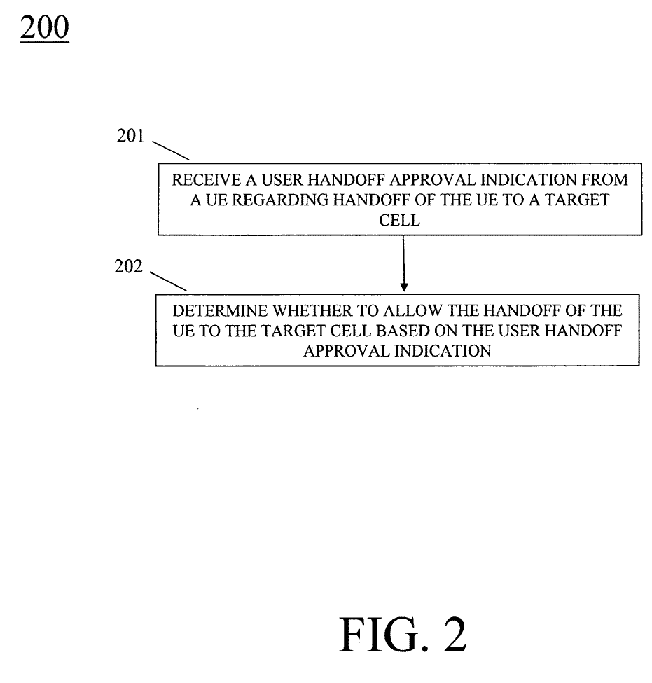

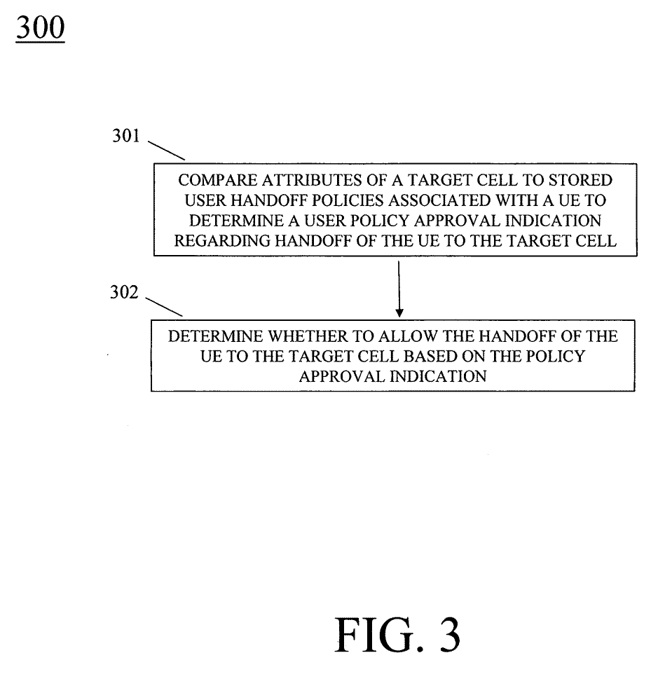

To address the need to have new techniques that are able to improve handoff decision-making, the network may employ a method such as that depicted in diagram 200 or 300 of FIGS. 2 and 3. In one method, the network receives (201) a user handoff approval indication from a UE (user equipment) regarding handoff of the UE to a target cell and then determines (202) whether to allow the handoff based on this user handoff approval indication. In another method, the network compares (301) attributes of a target cell to stored user handoff policies associated with a UE to determine a user policy approval indication regarding handoff to the target cell and then determines (302) whether to allow the handoff based on this policy approval indication. These methods afford users greater control in managing handoffs in the more varied and less uniform networking landscapes that technologies such as femto cell technology are creating.

### DETAILED DESCRIPTION OF EMBODIMENTS

The present invention can be more fully understood with reference to FIGS. 1-8. FIG. 1 is a block diagram depiction of a communication system 100 in accordance with multiple embodiments of the present invention. Communication system 100 includes mobile unit 101 and wireless network 102. Wireless network 102 includes network nodes 103 and 104, controller 105, database 106, and user handoff policies 107.

It should be understood that wireless communication systems typically include a plurality of mobile units, a plurality of network nodes, and additional equipment; however, only mobile unit 101, network nodes 103 and 104, controller 105, database 106, and user handoff policies 107 are depicted in FIG. 1 for the sake of clarity.

Mobile unit 101 is shown communicating via technology-dependent, wireless interfaces 111 and 112. Mobile units may also be referred to as user equipment (UEs). In addition, mobile unit platforms are known to span a wide variety of consumer electronic platforms such as, but not limited to, Voice over IP (VoIP) phones, mobile stations (MSs), access terminals (ATs), terminal equipment, mobile devices, gaming devices, personal computers, personal digital assistants (PDAs), and any other mobile equipment capable of being used in a wireless system.

Wireless network 102 is a network that facilitates communication between mobile units and other mobile units or devices connected to networks that are connected to wireless network 102. Network nodes 103 and 104 are network elements that provide over the air communication with mobile units. For example, depending on the technologies involved, a network node may be embodied in-part or in-full as, or within, a base station, an access point, and/or an access network.

Controller 105 is communicatively coupled, perhaps via intervening network equipment, to both network node 103 and database 106. Depending on the embodiment, controller 105 and database 106 may each be embodied in-part or in-full as, or within, any of a variety of network servers/platforms. For example, controller 105 may be embodied as a standalone server, embodied within a Service Control Point (SCP) platform, or embodied within a Mobility Application Part/Femto Interworking Function (MFIF) server. To provide another example, database 106 may be embodied as a standalone server or embodied within a platform such as a Home Subscriber System (HSS).

Depending on the embodiment, user handoff policies 107 may include any of a great variety of handoff policy information that may be structured in many different ways. For example, handoff policies may be expressed in the form of lists or rules or both that are able to indicate whether a particular handoff should be allowed, disallowed, or left to the user's real-time preference. For example, user handoff policies 107 may include a list of one or more cells that are approved for handoff, a list preferred for handoff, or a list not approved for handoff. Any of these lists may be more specific. For example, a list may be specific to a particular UE user handing off, to who is participating in the call/session, to the time of handoff, and/or to which service is being handed off (e.g., a voice call, video-telephony, a data download, a browser service, text messaging, an email service, etc.).

To provide another example, user handoff policies 107 may include one or more rules concerning which cells are approved for handoff, which cells are preferred for handoff, which cells are not approved for handoff, and/or when handoff should be approved by a user of the UE. Any of these rules may be more narrowly defined by incorporating into the rules factors or limitations that depend on UE user identity, identity of one or more call/session participants, what service or services are active, what cost is associated with the service(s), the time of day, the day of the week, the date, the access network type of a serving cell of the UE, the access network type of the target cell, and/or what security attributes are exhibited by the target cell. Security attributes such as whether access is limited to authorized users, whether access is limited by using explicit authorized user lists, whether access is limited by performing explicit authorization of users, etc. may be incorporated into rules. In addition, rules may include dependencies such as whether an involved cell is a macro cell or a femto cell.

Operation of embodiments in accordance with the present invention occurs substantially as follows, first with reference to FIGS. 2-4. FIGS. 2-4 depict logic flow diagrams of functionality some or all of which may be performed by a communications network involved in a network-directed handoff, depending on which embodiments are employed.

In the method of diagram 200, the network receives (201) a user handoff approval indication from a UE regarding handoff of the UE to a target cell and then determines (202) whether to allow the handoff based on this user handoff approval indication. This user handoff approval indication may convey either the user's desire to allow or to disallow the handoff. The user handoff approval indication may be received in response to a request sent by the network for user approval or it may be received without any particular prompting by the network. For example, a user about to make a call or start a session or having already begun the call/session may cause the UE to send an indication that handoffs of the UE during the call/session are either approved or disapproved. Alternatively, the user may want to simply enter a mode in which handoffs are to be all approved or all disapproved until the user instructs otherwise.

In the method of diagram 300, the network compares (301) attributes of a target cell to stored user handoff policies associated with a UE to determine a user policy approval indication regarding handoff to the target cell and then determines (302) whether to allow the handoff based on this policy approval indication. As described above with respect to user handoff policies 107, depending on the embodiment, the stored user handoff policies associated with the UE may include any of a great variety of handoff policy information that may be structured in many different ways.

In the method of diagram 400, the network compares (401) attributes of a target cell to stored user handoff policies associated with a UE to determine a user policy approval indication regarding handoff to the target cell. The network also receives (402) a user handoff approval indication from the UE regarding the handoff. As noted above, the user handoff approval indication may be received in response to a request sent by the network (perhaps triggered by the stored user handoff policies, e.g.) or it may be received without any particular prompting by the network. The network then uses either the user policy approval indication, the received user handoff approval indication, or both to determine (403) whether to allow the handoff. Presumably, the received user handoff approval indication from the UE would be determinative, but the stored user handoff policies may contain rules that would override the user indication.

In any of these methods, the determination may be to not allow the pending handoff. In such a case and depending on the embodiment, there are a number additional actions that may be taken. For example, the network may provide some indication to the UE user and/or another call/session participant that one or more of the services in use may terminate abruptly or why such a service has terminated abruptly. In another example, the network may update a count of disallowed handoffs occurring for this UE. In a final example, network equipment may indicate (to other network equipment or the UE) that signal strength measurements from the UE should not be used to trigger further handoff requests to this target cell, perhaps for some period of time or until some condition is satisfied.

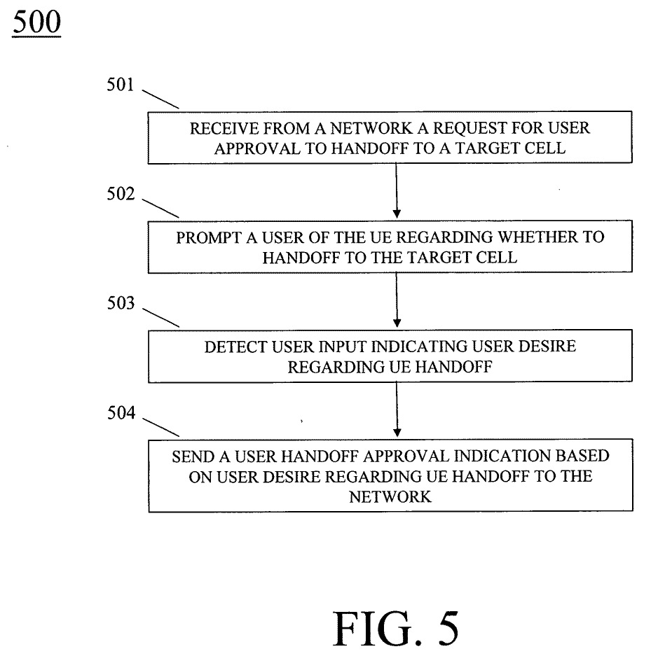

FIGS. 5-7 depict logic flow diagrams of functionality some or all of which may be performed by user equipment involved in a network-directed handoff, depending on which embodiments are employed. In diagram 500, a UE receives (501) from a network a request for user approval to hand off to a target cell, prompts (502) its user regarding whether to hand off to the target cell, and detects (503) user input indicating user desire regarding UE handoff. The UE then sends (504) a user handoff approval indication based on user desire regarding UE handoff to the network.

In an alternative embodiment (see diagram 600), the UE may not receive a request from the network or prompt its user, but merely detect (601) user input indicating user desire regarding UE handoff and then send (602) an indication to the network accordingly. For example, this may be the user indicating that handoffs should be allowed (or disallowed) for a call/session or going forward. In another alternative embodiment (see diagram 700), the UE may not prompt its user, but merely receive (702) a request for user approval to hand off to a target cell and then send (703) a user handoff approval indication based on user desire (701) regarding UE handoff that the UE has already obtained from the user or that the user has already indicated to the UE.

Furthermore, in addition to any of the above and when appropriate, a UE may convey various indications to a UE user. Examples include conveying an indication that a handoff is desirable, that one or more services may terminate abruptly, of why one or more services may terminate abruptly, of why one or more services have terminated abruptly, of why user approval to hand off is being requested, and of why the handoff could not proceed.

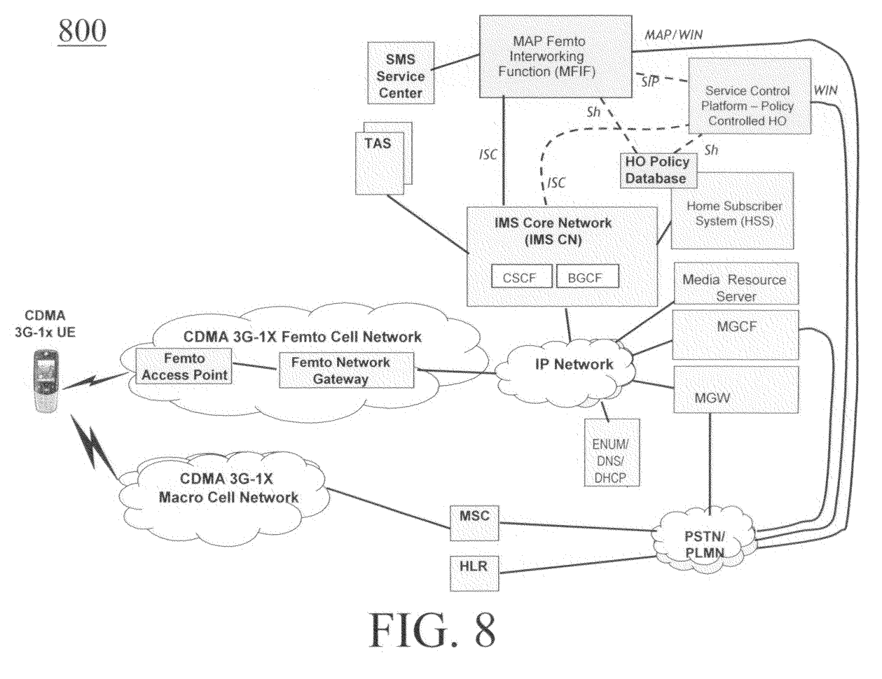

To provide a greater degree of detail in making and using various aspects of the present invention, a description of certain, quite specific, embodiments follows for the sake of example. FIG. 8 provides a detailed block diagram depiction of a wireless communication system 800 in accordance with certain embodiments of the present invention.

Generally speaking, wireless communication system 800 is a system for end-user, policy-based control of handoffs to/from femto cells that includes the following elements: a wireless macro network and a wireless femto cell network with a pre-existing handoff relationship; service logic in a platform such as an IMS application server or a Service Control Point (SCP); logic in the user device to interact with the service logic, e.g., to enable a user to express handoff preferences or to inform the user about certain handoff circumstances; and a policy database that contains, per user or per user category, rules, preferences, and/or lists (whether positive or negative).

The network-based service logic uses information in the policy database to determine whether a handoff should be allowed. For example, it may query the database regarding what handoffs are allowed for a specific application or user. This may include, for example, negative (i.e., disallowed) lists and/or positive (i.e., allowed) lists of target cells for a user or application. It may consult a table of costs associated with different types of access networks. In another example, it may decide to prompt the user in real-time with something like, “Call is about to hand off to higher priced service area. Continue?” Depending on the embodiment, a per call/per session identifier may be provided by the subscriber before or during the call/session to indicate whether handoff should be allowed for this call/session. This may be provided, for example, by the dialing of a star code or by the setting of a parameter in the INVITE message. Again, depending on the embodiment, if handoff into the femto cell is denied because of insufficient capacity (e.g., due to the number of users, the amount of signaling traffic, and/or the amount bandwidth being used already), then the service logic may notify the user that femto coverage would apply but presently cannot be used because it is at capacity.

In wireless communication system 800, the network keeps track of the access type that a user session is carried over. It may do this based on information from messaging such as the SIP INVITE or REGISTER messaging. For example, this access information may be provided in the P-access-network-identity header, which identifies the access network used to connect to the IMS network. Using this information, the network is able to determine whether the user is connecting via a macro cell or a femto cell.

As depicted in FIG. 8, handoff policy control while in the IMS domain (i.e., while connected via a femto cell) may be by an IMS application server such as the Mobility Application Part/Femto Interworking Function (MFIF) or by the SCP, depending on the embodiment. The SCP may be both wireless intelligent network (WIN) capable (for access from a circuit switched network such as CDMA 3G-1x) and SIP capable (for access from the IMS controlled domain). Also, depending on the embodiment, the interface to the SCP from the IMS domain may be directly from MFIF or via the IMS core network.

Furthermore, and also depending on the embodiment, the HO Policy database may be either part of the HSS or a separate database. If it is part of the HSS, a standard Sh interface from the MFIF and/or SCP may be used to access subscriber application data. The MFIF could query the HO Policy database using a protocol such as Diameter. Alternatively, if the handoff policy control logic is in an SCP, the network could query it using a CAMEL/IS-771-like trigger.

With numerous possible embodiments and the many and varied types of preferences, policies, and rules that a network operator may allow users to establish for handoffs, there is tremendous variety in the functionality that a wireless communication system may exhibit when employing user controlled handoffs. To illustrate some of this functional variety, a number of examples follow.

The first example involves a femto cell to macro cell handoff:

1. Stable call on a femto cell. User A is on a wireless phone served by a femto cell. User B is on a POTS phone.

2. User A moves to the edge of the femto's coverage. Signal strength measurements are continuously sent from the user device to the femto cell. At a particular threshold, the femto cell contacts the MFIF to request handoff.

3. The MFIF determines whether handoff should be allowed for this call. For this scenario, MFIF queries an SCP or application server to find this out. This determination may be based on pre-provisioned data for this subscriber and/or a query of user A regarding whether this handoff should be allowed. The pre-provisioned data for this subscriber may include, e.g., who the other party is on the call, what application is currently being used (e.g., voice call, video telephony, file download, etc.), what types of access networks are involved (going to and/or coming from), the time of day and/or the day of the week.

4A. If the handoff is allowed, then the handoff proceeds.

4B. If the handoff is denied by the service logic or by the user, this may result in separate announcements to User A and User B. For example, User A may be provided a warning tone, or the network may provide an announcement to User A. The announcement to User A may say, e.g., “Your call is about to drop because you are leaving the femto coverage area.” If the call does indeed drop, then the announcement to User B may say, e.g., “Your call has dropped because the other party didn't want to pay for it to continue.” The directive to play the announcement to User B may come from the MFIF.

5. For handoffs that are denied, the network may record the count of this event for this user, and the service provider may later use this per-subscriber information to market additional services/femto cell coverage to this user. Additionally or alternatively, the network may stop taking or processing signal strength measurements of femto cells or macro cells to which a handoff will be denied anyway. Potentially, this could reduce handoff related signaling and processing load.

The second example involves a macro cell to femto cell handoff and a concern about potential femto cell eavesdropping:

0. Provision subscriber data in the network regarding which femto cells a subscriber can use. This may be based on femto cell identity or characteristics. The subscriber data may be a positive list or a negative list. For example, allow subscriber to hand off to cells on this list x, y, z, . . . or allow subscriber to hand off only to cells that use explicit authorized user lists, i.e., cells not open to public access without authorization.

1. Stable call in the macro network. User A is on a wireless phone served by a macro cell. User B is on a POTS (Plain Old Telephone Service) phone.

2. User A moves into the edge of this femto cell's coverage. Signal strength measurements from handset are continuously sent from the user device to the serving cell (a macro cell). At a particular threshold, the macro cell contacts the serving MSC or RNC to request handoff.

3. The MSC or RNC determines whether handoff should be allowed from macro cell to femto cell for this call. In this scenario, the MSC/RNC/PDSN queries an SCP or application server to make this determination. The decision criteria may be based on the pre-provisioned data for this subscriber with information such as whether this subscriber is allowed to hand off to this particular femto cell, based on its cell identification information, whether this femto cell performs explicit authorization of users, and/or whether this subscriber requires service only from femto cells using authorization. Also or alternatively, User A may be queried for whether the handoff should be allowed. Such functionality may be a desirable end-user security feature, particularly to enterprises that deploy femto cells across office campuses and do not want their enterprise users to attach to unsecured or rogue femto cells.

4A. If the network determines that the handoff to the femto cell should be allowed, the handoff proceeds.

4B. If the handoff is denied by the service logic or by the user, the call may either continue or drop, depending on whether the macro coverage is sufficient or not.

In another scenario, this basic procedure may be followed for a stable call on a femto cell, instead of the macro cell, that is trying to hand off into the femto cell referred to in this procedure.

The third example involves a macro cell to femto cell handoff attempt where the femto cell is full and cannot accept the handoff:

0. Provision subscriber data in the network to indicate which femto cell(s) is acceptable and/or preferred for handoffs by this user (e.g., maybe indicate who owns the femto).

1. Stable call in the macro network. User A is on a wireless phone served by a macro cell.

2. User A moves to the edge of this femto cell's coverage, and signal strength measurements indicate that a femto cell handoff is appropriate.

3. MSC or RNC determines that handoff should be allowed from macro cell to femto cell for this call. (MSC/RNC/PDSN queries an SCP or application server to determine that the handoff should be allowed and that this is a preferred femto cell for this user.) However, in this case, the handoff cannot proceed because the femto cell is already “full” with its maximum number of users already being supported.

4. The network notifies the user that handoff to the femto cell is not possible at the present time because the candidate femto cell does not have enough capacity. This notification could come in the form of an announcement, tone, or text message, and may indirectly encourage the purchase of additional femto cells to provide more adequate femto resources. The call then remains in the macro network.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for facilitating user control of handoffs, the method comprising:
performing at least one of:
receiving a user handoff approval indication from a UE regarding handoff of the UE to a target cell or
comparing attributes of the target cell to stored user handoff policies associated with the UE to determine a user policy approval indication regarding handoff to the target cell;
determining whether to allow the handoff of the UE to the target cell based on at least one of the user handoff approval indication or the policy approval indication.

2. The method as recited in claim 1, wherein the handoff of the UE to the target cell is a network-directed handoff.

3. The method as recited in claim 1, further comprising sending a request for user approval to hand off to the target cell.

4. The method as recited in claim 1, wherein receiving the user handoff approval indication comprises receiving with respect to a call or session involving the UE one of
an indication that a user of the UE approves handoffs of the UE during the call or session or
an indication that the user of the UE disapproves handoffs of the UE during the call or session.

5. The method as recited in claim 1, wherein the user handoff policies associated with the UE comprise at least one of
a list of one or more cells that are approved for handoff,
a list of one or more cells that are preferred for handoff,
a list of one or more cells that are not approved for handoff,
a list of one or more cells that are approved for handoff for one or more UE users,
a list of one or more cells that are preferred for handoff for one or more UE users,
a list of one or more cells that are not approved for handoff for one or more UE users,
a list of one or more cells that are approved for handoff for one or more call/session participants,
a list of one or more cells that are preferred for handoff for one or more call/session participants,
a list of one or more cells that are not approved for handoff for one or more call/session participants,
a list of one or more cells that are approved for handoff of one or more services,
a list of one or more cells that are preferred for handoff of one or more services,
a list of one or more cells that are not approved for handoff of one or more services,
a list of one or more cells that are approved for handoff during a particular time period,
a list of one or more cells that are preferred for handoff during a particular time period, or
a list of one or more cells that are not approved for handoff during a particular time period.

6. The method as recited in claim 5, wherein the one or more services comprises a service having a service type of voice call services, video-telephony services, data download services, browser services, text messaging services, or email services.

7. The method as recited in claim 1, wherein the user handoff policies associated with the UE comprise at least one of
a rule concerning which cells are approved for handoff,
a rule concerning which cells are preferred for handoff,
a rule concerning which cells are not approved for handoff, or
a rule concerning when handoff should be approved by a user of the UE.

8. The method as recited in claim 7, wherein the rule concerning which cells are approved for handoff comprises a rule concerning which cells are approved for handoff based on at least one of
a UE user identity,
an identity of one or more call/session participants,
one or more active services,
a cost associated with one or more active services,
time of day,
day of week,
date,
the access network type of a serving cell of the UE,
the access network type of the target cell, or
one or more security attributes of the target cell.

9. The method as recited in claim 8, wherein one or more security attributes of the target cell comprises at least one of
limiting access to authorized users,
limiting access by using explicit authorized user lists, or
limiting access by performing explicit authorization of users.

10. The method as recited in claim 8, wherein access network type comprises one of macro cell access or femto cell access

11. The method as recited in claim 7, wherein the rule concerning which cells are preferred for handoff comprises a rule concerning which cells are preferred for handoff based on at least one of
a UE user identity,
an identity of one or more call/session participants,
one or more active services,
a cost associated with one or more active services,
time of day,
day of week,
date,
the access network type of a serving cell of the UE,
the access network type of the target cell, or
one or more security attributes of the target cell.

12. The method as recited in claim 7, wherein the rule concerning which cells are not approved for handoff comprises a rule concerning which cells are not approved for handoff based on at least one of
a UE user identity,
an identity of one or more call/session participants,
one or more active services,
a cost associated with one or more active services,
time of day,
day of week,
date,
the access network type of a serving cell of the UE,
the access network type of the target cell, or
one or more security attributes of the target cell.

13. The method as recited in claim 7, wherein the rule concerning when handoff should be approved by the user of the UE comprises a rule concerning when handoff should be approved by the user of the UE based on at least one of
an identity of one or more call/session participants,
one or more active services,
a cost associated with one or more active services,
time of day,
day of week,
date,
the access network type of a serving cell of the UE,
the access network type of the target cell, or
one or more security attributes of the target cell.

14. The method as recited in claim 1, further comprising:
when determining not to allow the handoff of the UE to the target cell, providing an indication to a UE user that one or more services may terminate abruptly.

15. The method as recited in claim 1, further comprising:
when determining not to allow the handoff of the UE to the target cell, providing an indication to at least one of a UE user or another call/session participant why one or more services terminated abruptly.

16. The method as recited in claim 1, further comprising:
when determining not to allow the handoff of the UE to the target cell, updating a count of disallowed handoffs occurring for this UE.

17. The method as recited in claim 1, further comprising:
when determining not to allow the handoff of the UE to the target cell, indicating that signal strength measurements from the UE should not be used to trigger further handoff requests to the target cell.

18. A method for facilitating user control of handoffs, the method comprising:
performing at least one of:
receiving from a network a request for user approval to hand off to a target cell,
prompting a user of the UE regarding whether to hand off to the target cell, or
detecting user input indicating user desire regarding UE handoff;
sending a user handoff approval indication based on user desire regarding UE handoff to the network.

19. The method as recited in claim 18, wherein detecting user input indicating user desire regarding UE handoff comprises detecting, with respect to a call or session involving the UE, one of
an indication that a user of the UE approves handoffs of the UE during the call or session or
an indication that the user of the UE disapproves handoffs of the UE during the call or session.

20. The method as recited in claim 18, further comprising:
performing at least one of:
conveying an indication to a UE user that one or more services may terminate abruptly,
conveying an indication to a UE user of why one or more services may terminate abruptly,
conveying an indication to a UE user of why one or more services terminated abruptly,
conveying an indication to a UE user that a handoff is desirable,
conveying an indication to a UE user of why user approval to hand off is being requested, or
conveying an indication to a UE user of why a handoff could not proceed.
